(19) United States
(12) Patent Application Publication
(10) Pub. No.: US 2020/0372590 A1
(43) Pub. Date: Nov. 26, 2020

(54) OPTIMIZED TRANSPORTATION SELECTION

(71) Applicant: International Business Machines Corporation, Armonk, NY (US)

(72) Inventors: Pawan Chowdhary, San Jose, CA (US); Sunhwan Lee, San Mateo, CA (US); Guangjie Ren, Belmont, CA (US); Raphael I. Arar, Santa Cruz, CA (US)

(21) Appl. No.: 16/422,142

(22) Filed: May 24, 2019

(51) Int. Cl. G06Q 50/14; G06F 16/29; G06F 16/2457; G06F 16/248; G06Q 10/02; G06N 5/02

(52) U.S. Cl. CPC G06Q 50/14; G06F 16/29; G06N 5/02; G06F 16/248; G06Q 10/025; G06F 16/24578

(57) ABSTRACT

Facilitation of optimized transportation selection relative to user travel objectives and user context is provided. A system can include a memory and a processor that executes computer executable components. The computer executable components can include: an objective component that determines travel objectives of a user; a context component that determines context of the user; an analyzer component that analyzes transportation related data relevant to the travel objectives of the user, wherein the analyzer component performs a utility-based analysis that weighs costs versus benefits associated with respective transportation options relative to the travel objectives of the user; and an optimization component that outputs a travel itinerary to the user that includes an optimized transportation selection relative to the user travel objectives and user context.

### BACKGROUND

The subject disclosure relates generally to travel itinerary recommendations and, more particularly, to optimized transportation selection relative to user travel objectives and user context.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products provide optimized transportation selection relative to user travel objectives and user context.

Travelers have many options when selecting transportation options as they plan an itinerary for travel or make decisions in real time. Current applications provide travel recommendations associated with transportation options based primarily on objective criteria such as cost and time. Such applications are useful but do not address other factors that are associated with a user's travel objectives and context.

Various tools can be established to consider other relevant factors associated with a user's travel objectives and context in order to provide improved travel recommendations associated with transportation options that enable a user to achieve the user's travel objectives. In one or more embodiments, a system, a method and a computer program product are provided herein to enable optimized transportation selections.

In accordance with an embodiment, a system comprises: a memory and a processor that executes computer executable components. The computer executable components can include an objective component that determines travel objectives of a user, a context component that determines context of the user, an analyzer component that analyzes transportation related data relevant to the travel objectives of the user, wherein the analyzer component performs a utility-based analysis that weighs costs versus benefits associated with respective transportation options relative to the travel objectives of the user, and an optimization component that outputs a travel itinerary to the user that includes an optimized transportation selection relative to the user travel objectives and user context.

In accordance with another embodiment, a computer-implemented method comprises: determining, by a device operatively coupled to a processor, travel objectives of a user, determining, by the device, context of the user, analyzing, by the device, transportation related data relevant to the travel objectives of the user, wherein a utility-based analysis is performed that weighs costs versus benefits associated with respective transportation options relative to the travel objectives of the user, and outputting, by the device, a travel itinerary to the user that includes an optimized transportation selection relative to the user travel objectives and user context.

In yet another embodiment, a computer program product comprises a computer readable storage medium having program instructions embodied therewith, the program instructions executable by a processor to cause the processor to: determine, by the processor, travel objectives of a user, determine, by the processor, context of the user, analyze, by the processor, transportation related data relevant to the travel objectives of the user, wherein a utility-based analysis is performed that weighs costs versus benefits associated with respective transportation options relative to the travel objectives of the user, and output, by the processor, a travel itinerary to the user that includes an optimized transportation selection relative to the user travel objectives and user context.

### DESCRIPTION OF THE DRAWINGS

FIG. 1 illustrates a block diagram of an optimized transportation selection system in accordance with one or more embodiments described herein.

FIG. 2 illustrates another example of an optimized transportation selection system in accordance with one or more embodiments described herein.

FIG. 3 illustrates a block diagram of yet another example of an optimized transportation selection system in accordance with one or more embodiments described herein.

FIG. 4 illustrates a block diagram of yet another example of an optimized transportation selection system in accordance with one or more embodiments described herein.

FIG. 5 illustrates a block diagram of yet another example of an optimized transportation selection system in accordance with one or more embodiments described herein.

FIG. 6 illustrates an example, non-limiting algorithm to facilitate an optimized transportation selection system in accordance with one or more embodiments described herein.

FIG. 7 illustrates an example, non-limiting algorithm to facilitate an optimized transportation selection system in accordance with one or more embodiments described herein.

FIG. 8 illustrates a block diagram of yet another example of an optimized transportation selection system in accordance with one or more embodiments described herein.

FIG. 9 illustrates a block diagram of yet another example of an optimized transportation selection system in accordance with one or more embodiments described herein.

FIG. 10 illustrates a block diagram of yet another example of an optimized transportation selection system in accordance with one or more embodiments described herein.

FIG. 11 illustrates yet another example of an optimized transportation selection system in accordance with one or more embodiments described herein.

FIG. 12 illustrates a block diagram of yet another example of an optimized transportation selection system in accordance with one or more embodiments described herein.

FIG. 13 illustrates a flow diagram of an example of an optimized transportation selection computer-implemented method in accordance with one or more embodiments described herein.

FIG. 14 illustrates a flow diagram of another example of an optimized transportation selection computer-implemented method in accordance with one or more embodiments described herein.

FIG. 15 is a schematic diagram of an example operating environment in accordance with one or more implementations described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

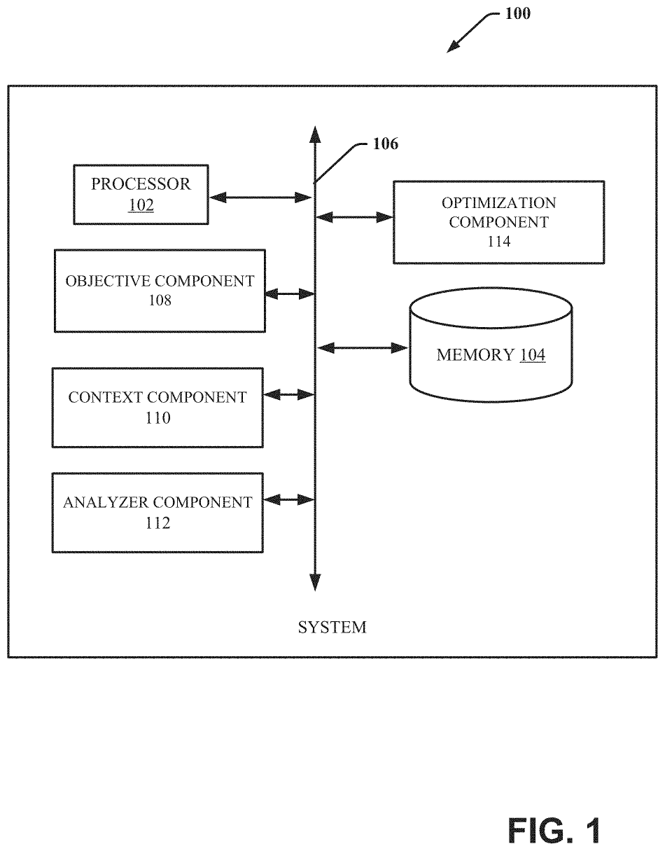

Embodiments described herein include systems, methods, and computer program products that facilitate optimized transportation selection. FIG. 1 illustrates a block diagram of an example optimized transportation selection system 100 in accordance with one or more embodiments described herein. The system includes a processor 102, and a system memory 104. The system 100 can further include a system bus 106 that can couple various components, including, but not limited to, an objective component 108, a context component 110, an analyzer component 112 and an optimization component 114. The objective component 108 determines travel objectives of a user. The context component 110 determines context of the user. The analyzer component 112 analyzes transportation related data relevant to travel objectives of the user, wherein the analyzer component 112 performs a utility-based analysis that weighs costs versus benefits associated with respective transportation options relative to the user travel objectives. The optimization component 114 outputs a travel itinerary to the user that includes an optimized transportation selection relative to the user travel objectives and user context.

In certain embodiments, the memory 104 can be contained in at least one of a cloud computing system or a user device such as a desktop computer, a laptop computer, a tablet computer, a smartphone, smartwatch, a television or the like.

In certain embodiments, the objective component 108 determines travel objectives of a user. In one example, the objective component 108 can include a questionnaire for a user to complete that includes questions about a planned trip. The questionnaire can include broad questions such as whether a trip is for personal or business reasons. The questionnaire can also include specific questions about the purpose of a trip and specific itinerary items included in the trip. For example, a user may answer that a business trip can have a primary purpose of a meeting with a large customer or sales prospect but can also include meeting a friend for drinks in the evening after the meeting. The questionnaire can also include questions associated with the importance of being on time for items included in the itinerary. For example, a user can assign the highest priority to a job interview or meeting with a large customer or his boss. The user can also assign lower priority to meeting a friend for dinner on the evening before an important meeting. The questionnaire can also include questions associated with a user's selection of or preference for transportation options for a trip. For example, a user may indicate a preference to take air travel to a meeting but not indicate preferences for ground transportation. In another example, a user's answer to questions can determine subsequent questions generated by the objective component 108. For example, if the user answers that a trip is for personal purposes, additional questions generated by the objective component 108 can include questions regarding whether family members or friends will be traveling with the user. If the user answers that a trip is for business purposes, additional questions generated by the objective component 108 can include questions regarding whether colleagues or clients will be traveling with the user.

In another embodiment, the system 100 can make inferences regarding travel objectives from the user, e.g., based on email communications, texts, calendars, current location, reservations, Internet searches, event bookings, monitored conversations (e.g., using an Alexa® device or the like), correlation of information gathered from friends, colleagues, family, etc. to glean travel objectives of the user. For example, if a user makes a reservation for a show in another city, the objective component 108 can infer that a travel itinerary to the city and then to the show will be required. If the user purchases two tickets and has a pattern of taking the user's spouse to similar shows, then the objective component can infer that the travel itinerary will include travel for the user's spouse. If conversations between the user and the user's spouse detected on an Alexa® device or the like indicate plans to have dinner before the show, then the objective component 108 can infer that time before the show will be reserved for dinner, requiring additional ground transportation segments in the itinerary. If searches by the user or the user's spouse on the Internet or restaurant applications indicate the need for dinner reservations for four people for dinner, the objective component 108 can infer that ground transportation from the restaurant to the show will need to accommodate four people.

In another example, the objective component 108 can include a questionnaire for a user to complete that establishes a travel profile for the user that includes questions about the user's age, other demographic information, travel preferences associated with types of travel, travel history, business expense history, travel memberships, frequent travel companions and other attributes that can be used to create a travel profile associated with the user. This travel profile can be used by the objective component 108 to generate default travel objectives for a user with respect to certain types of travel and more efficiently generate questions for the user with respect to the user's travel objectives associated with a specific trip. For example, a user can indicate that a meeting with the user's boss or a large customer will always be assigned the highest priority associated with the need to be on time. In another example, a user can indicate that a certain ride sharing company or car rental company should be the default option when that transportation option is selected. In another example, a user can indicate the minimum level of cost savings that would be necessary for another ride sharing company or car rental company to be considered over the default option. In another example, a user can indicate that in cases where a train or other form of public transportation is considered as an option, only options with available first-class seating should be considered on business trips in order to provide the user the opportunity to work during travel time.

In another example, some or all of a user's demographic information and other information associated with travel history and preferences can be obtained by the objective component 108 through integration with an external system or database. For example, the objective component 108 may receive information from sources such as a user's frequent flyer accounts, hotel affinity accounts, ride sharing accounts and the like. In another example, the objective component 108 can obtain the travel policies of a user's employer in order to determine the user's travel profile for business trips. For example, the user's employer may permit the use of a private car service or business class air travel only for certain types of business travel.

In another example, the objective component 108 can enable a user to select how the user's transportation preferences will vary based upon context of the user. For example, a user can indicate that the user prioritizes the ability to work on the way to an important meeting but does not prioritize the ability to work after a meeting. Thus, a cab or a ride sharing service will be prioritized on the way to an important meeting over a subway or other crowded public transportation, but not on the way back. In another example, a user can indicate that transportation options in New York City can always include a cab but that a cab should only be considered as a last resort in Los Angeles. In another example, a user can indicate that a cab or a ride sharing service is always preferred over public transportation when the user is traveling with the user's spouse or children.

In another example, the objective component 108 can determine probabilities associated with how a user's transportation preferences will vary based upon context of the user based upon information associated with the user's travel history. For example, if a user's travel history displays a pattern of walking to meetings within a certain distance when the user is alone but displays a pattern of ordering a cab or ride sharing service when traveling with the user's boss, the objective component 108 can infer a preference to order a cab or ride sharing service when the user is traveling with his boss. In another example, if a user's travel history displays a pattern of walking to meetings within a certain distance when the user is alone but displays a pattern of ordering a cab or ride sharing service when weather conditions include rain or temperatures below a certain level, the objective component 108 can infer a preference order a cab or ride sharing service under such weather conditions.

In another example, the objective component 108 can receive information from sources such as a user's business or personal email, calendar or instant messaging applications. For example, if a user books a flight to a destination and enters a meeting in the user's work calendar, the questions asked by the objective component 108 to determine the user's travel objectives for the trip can take into account such information. The objective component 108 can also compare such proposed flight and scheduled meeting to the user's travel history to infer additional transportation itinerary items, and the questions asked by the objective component 108 can be crafted to confirm the inferred itinerary items. For example, if the user consistently rents a car when meeting with a customer in Los Angeles, the objective component 108 can ask a question confirming this ground transportation option as opposed to a broad question about all transportation options available when the user arrives in Los Angeles.

In certain embodiments, the context component 110 determines context of a user. Context of a user can include a wide variety of attributes associated with the user at a given time, such as location, time of day, day of the week, calendar date, travel companions, participants in business meetings, status of work projects and the like. Context of a user can also include extrinsic data that can affect a user's transportation preferences at a given time such as weather, traffic, transportation delays and the like.

In one example, the context component 110 can determine the location of a user using the Global Positioning System (GPS) application on the user's personal user device such as a smartphone or tablet computer.

In another example, the context component 110 can determine context of a user in relation to itinerary items of a scheduled trip. For example, a user may have scheduled a series of meetings with the need for ground transportation between each meeting and to an airport after the final meeting, and the context component 110 can determine if the user is in a meeting longer than the time scheduled in the itinerary which may affect the importance of time associated with ground transportation options if the user is running late.

In another example, the context component 110 can obtain extrinsic data to determine context of a user through integration with an external system or database. For example, extrinsic data such as weather or traffic information can be collected using application programming interface (API) services of third-party applications. Information regarding delays in transportation services can be obtained using APIs of airlines and public transit services. The number of vehicles available in a certain radius associated with a ride sharing service can be obtained using APIs of such ride sharing services.

In another example, the context component 110 can utilize a user's calendar and communication accounts to determine context of the user. For example, the context component 110 can access a user's calendar, email account and instant messaging account to determine changes to meeting agenda items or participants that can affect the importance of a meeting. If a user's boss accepts an invitation to a meeting on a user's calendar that otherwise would have only included the user's colleagues, then the importance of the user's timely arrival to the meeting can be increased by the context component 110. In another example, the content of an email or instant message can indicate an increased or decreased importance of a user's timely arrival to an item on the user's itinerary.

In certain embodiments, the analyzer component 112 analyzes transportation related data relevant to the travel objectives of a user, wherein the analyzer component 112 performs a utility-based analysis that weighs costs versus benefits associated with respective transportation options relative to the travel objectives of the user. In one example, the analyzer component 112 can access schedule and cost data associated with transportation options. For example, the analyzer component 112 can access airline data, train data, public transit tables, ride sharing applications, autonomous vehicle applications, cab applications, private car services, rental car services, parking rates and availability and the like. The analyzer component 112 can then utilize such data to identify transportation options that meet the travel objectives of the user with respect to time and cost. For example, for a segment of a trip from an airport to a hotel in a destination city, the analyzer component 112 can compare the estimated travel time using a cab or a train. For the train the analyzer component 112 can utilize the train schedule and any available data regarding how often the train arrives at the scheduled time. For the cab the analyzer component 112 can take into account factors such as estimated wait time for cab lines at the airport at the time the user is expected to arrive at the airport and estimated travel time based on destination and traffic patterns. In another example, the analyzer component 112 can determine the likelihood that additional costs associated with a transportation option will be incurred. For example, the analyzer component 112 can determine whether additional fees for carry-on or checked luggage will be incurred. In another example, when calculating the cost of a rental car as a ground transportation option, the analyzer component 112 can take into account the likelihood of additional expenses for gas and parking based upon a user's destination and itinerary.

In addition to quantitative factors such as time and cost, the analyzer component 112 can also take into account qualitative factors such as reliability, comfort, convenience and a user's preferences determined by the objective component 108 with respect to a trip. In one example, the analyzer component 112 can compare transportation options based on duration and expected time of arrival. For example, the analyzer component 112 can compare transportation options based on reliability. For example, when comparing a direct flight and a flight with connections, the direct flight will generally be determined by the analyzer component 112 to be more reliable as due to the risks associated with a possible missed connection, absent other factors affecting reliability. Also, when comparing two connecting flights, the connecting flight with a longer layover time in the connecting airport will generally be determined by the analyzer component 112 to be more reliable, absent other factors affecting reliability. In another example, the analyzer component 112 can consider if a connection will require a user to walk to another terminal which can affect the likelihood of making a connection. In another example, comfort associated with airline travel can be determined by factors such as leg room, available media options and seat availability. For example, two flight options can have similar costs and arrival times, but one only offers base economy seating with the little legroom while the other option offers standard economy with average legroom. In another example, the objective component 108 can determine that legroom is a very important qualitative factor for a user. In that case, the analyzer component 112 can take that into account when weighing costs versus benefits of a less expensive flight with seating that offers little legroom versus a more expensive flight that offers acceptable legroom. In another example, the analyzer component 112 can compare transportation options based on convenience. For example, the objective component 108 can determine that that the ability work when using ground transportation between meetings is an important factor for a user regarding a particular trip. In that case, the analyzer component 112 can take the user's preference into account when weighing costs versus benefits of car rental options versus ride sharing options that provide the convenience of the ability to work while traveling.

In another example, the analyzer component 112 can take into account how selections of transportation options during one segment of a trip can affect available choices for segments later in the trip. For example, if a user elects to drive to an airport when departing for a trip from the airport, the user's transportation options upon the user's arrival after the user's return flight will be limited to driving home from the airport. Taking a cab or ride sharing service home from the airport will not be an option. Thus, when performing an analysis of transportation options for a user to an airport to begin a trip that includes a return flight, the analysis option 112 will take into account that the selection of the option to drive to the airport will include the cost of parking rates for the duration of the trip and that driving home will be the only option after the return flight.

In another example, the analyzer component 112 can take into account how selections of transportation options for a user can be affected by the number and type of the user's travel companions. For example, the analyzer component 112 can determine that it will be less expensive for the user to take a train over a cab when traveling alone, but with three traveling companions the cab is the better option since the cost of the cab is spread across four people while each passenger would require a separate train ticket. In another example, the analyzer component 112 can place increased weight on the travel restrictions of one or more travel companions. For example, traveling with small children or elderly persons make it much more difficult to take public transportation such as a subway. If a travel companion has difficulty walking, then walking to a destination or walking to a train terminal to take the train will not be feasible options. If a travel companion requires a wheelchair at an airport, then the additional travel time required for air travel will be taken into account by the analyzer component 112.

In another example, the analyzer component 112 can employ crowdsourced data to facilitate analysis of transportation options. For example, the analyzer component 112 can utilize user reviews and ratings posted on travel sites or message boards in order to determine qualitative factors used to analyze transportation options. In one example, two airlines can offer similar legroom and amenities in premium seating sections, but one airline consistently receives higher ratings on travel websites for the comfort level of their premium seating. In another example, user reviews can indicate that one ride sharing service has a much higher rate of driver cancellations in certain cities as compared to another ride sharing service. In another example, a user's employer can collect employee feedback associated with transportation options which can be utilized by the analyzer component 112 to assess qualitative factors such as reliability, comfort, convenience and the like. In another example, the analyzer component 112 can utilize comments posted by travelers on social media accounts. For example, delays in air travel or public transportation can be detected by comment trends on social media accounts prior to announced travel delays.

In certain embodiments, the optimization component 114 outputs a travel itinerary to a user that includes an optimized transportation selection relative to the user travel objectives and user context. In one example, the optimization component 114 can take into account quantitative factors and qualitative factors analyzed by the analyzer component 112 and then output the best transportation selection relative to a user's context with respect to one or more segments of the user's travel itinerary. The context of a user taken into account by the optimization component 114 can include any factor that can impact the quantitative factors or qualitative factors that affect the user's travel objectives. For example, weather can cause delays or cause some transportation options such as hailing a cab to be less reliable or convenient. Traffic can affect the availability and arrival times of vehicle-based ground transportation options. Location and time of day can affect the cost, availability and reliability of transportation options. The number and identity of travel companions can affect how a user perceives the quality of available transportation options.

In another example, if the user's context changes or the objective component 108 determines a change in the user's travel objectives, then the optimization component 114 can update the best transportation selection with respect to one or more segments of the user's travel itinerary. For example, weather may cause travel delays that impact the availability of transportation options. Weather can also change the convenience of transportation options. For example, walking to a subway station to travel to a meeting is less convenient if it begins to rain heavily. In another example, a user may be unexpectedly joined by a group of colleagues, requiring the use of a private car or premium ride sharing vehicle as opposed to the standard ride sharing vehicle originally selected by the optimization component 114.

In another example, the importance of a user's timely arrival to an item on the user's itinerary can be considered in the determination by the optimization component 114 of the optimized transportation selections associated with itinerary segments leading up to the itinerary item. For example, the objective component 108 can determine that a job interview in New York scheduled by a user has the highest importance regarding timely arrival. In this example, the cost of potentially being late for the interview is far higher than any benefit associated with less expensive or more comfortable transportation options. Thus, the optimization component 114 can prioritize reliability over other factors. As a result, with respect to air travel on the way to the interview, direct flights will be prioritized over connecting flights even if the cost is higher. Also, with respect to ground transportation to the interview after arriving in New York City, the train into the city will be prioritized over a cab or ride sharing service in order to eliminate the possibility that traffic can cause a delay, even if the train is determined by the objective component 108 to be the least comfortable option for the user. In another example, changes in the user's context can require an updated output by the optimization component 114. For example, if the user's flight arrives late and the user misses the scheduled train into the city, the optimization component 114 can output a new transportation option that takes into account the user's travel objective of timely arrival and the user's updated context. In this case, traffic becomes a necessary risk if the only remaining ground transportation options include a cab, a ride sharing service or a private car service, but the optimization component 114 can select the ground transportation option that would require the shortest wait prior to departure. Accordingly, factors such as the length of cab lines at the airport, the proximity of available vehicles offering ride sharing services and the availability of private car services at the airport can be taken into account by the optimization component 114.

In another example, the optimization component 114 outputs a travel itinerary to a user that includes one or more optimized transportation selections relative to the user travel objectives and user context. For example, if multiple transportation selections substantially satisfy a user's travel objectives given the user context, then the optimization component 114 can output multiple transportation selections as optimized transportation selections. In another example, the optimization component 114 can output a preferred transportation selection in addition to other recommended options. In another example, in cases where the optimization component 114 outputs multiple transportation selections as optimized transportation selections, the optimization component 114 can indicate to the user the quantitative or qualitative factors that support each transportation selections, thus providing the user with additional information that can be used by the user to select among the transportation selections.

In another example, the output of the optimization component 114 can be revised by adjusting the extent to which various quantitative or qualitative factors can be considered by the optimization component 114. For example, a user may want to see what the output of the optimization component 114 would be if the weight given to cost as a factor is reduced or eliminated. In another example, a user may want to see the what output of the optimization component 114 would be if more weight is given to the user's comfort preferences.

In another example, the weight given by the optimization component 114 to various quantitative or qualitative factors can be modified to conform to the travel policies of a user's employer. For example, the optimization component 114 can give more weight to the factor of cost to the extent that cost meets the travel expense guidelines established by the user's employer.

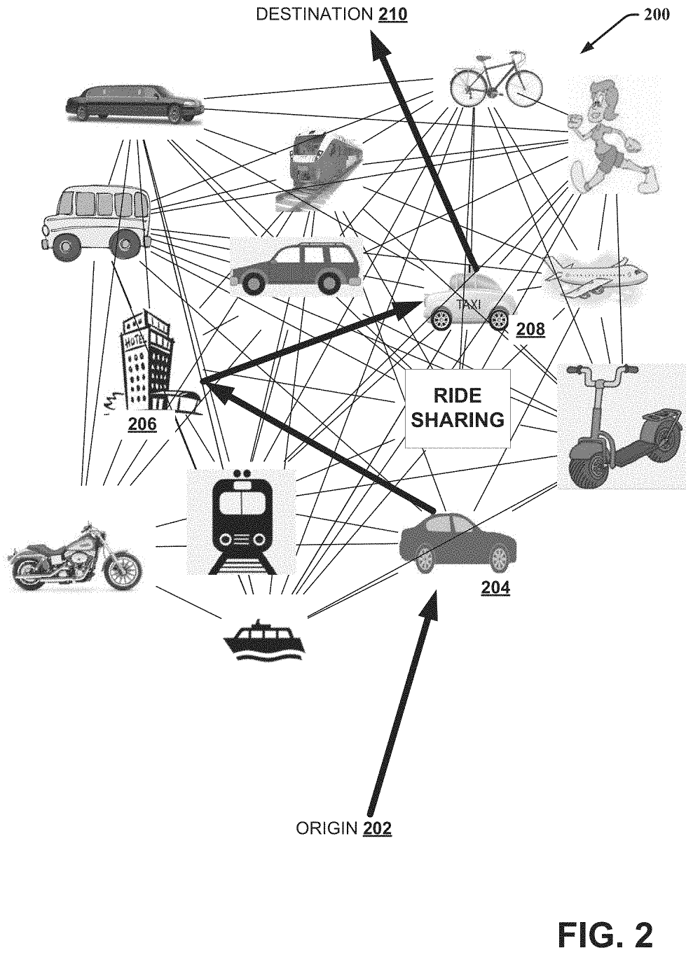

FIG. 2 illustrates another example of an optimized transportation selection system in accordance with one or more embodiments described herein. Repetitive description of like elements employed in other embodiments described herein is omitted for sake of brevity. FIG. 2 depicts an example 200 of the many transportation options that are available for each segment of a travel itinerary and the need to compare each transportation option to every other available option using a variety of attributes given a user's travel objectives and context. Often such comparisons require decisions in real time and it is not feasible for humans to review and evaluate the large corpus of data represented by the available travel options and the various attributes to be considered when comparing travel options in order to determine an optimal transportation option. As can be seen in the diagram, the numerous transport options and combinations and sub-combinations results in an almost intractable problem for a human to process each and every combination in real-time to determine an optimal set of transport combinations to navigate from an origin to a destination factoring user preferences, constraints and context. In this example 200, a user needs to travel to a meeting in another city that takes place early in the morning. Due to the time of the meeting, the optimization component 114 determines that the user will arrive in the city where the meeting will take place the day before the meeting. Given the distance of the city from the user's location 202, the optimization component 114 determines that driving to the meeting destination 210 with the user's vehicle 204 is the optimal transportation option for the initial segment of the travel itinerary for this trip. By leaving the day before, the user will require a hotel 206. For the next transportation segment from the hotel 206 to the meeting destination 210 on the morning of the meeting, the initial travel itinerary generated by the optimization component 114 had initially determined that the user would drive the user's vehicle 204 to the meeting destination 210. However, the user receives a text the morning of the meeting that a colleague will be meeting the user at the hotel 206 and traveling with the user to the meeting destination 210. The user had indicated a preference to be able to work and review notes on the way to the meeting. Given the user's travel preferences and context, the optimization component 114 determines that the user should take a cab 208 to the meeting destination 210 as opposed to driving the user's vehicle 204, thus enabling the user and the user's colleague to work and review notes on the way to the meeting destination 210.

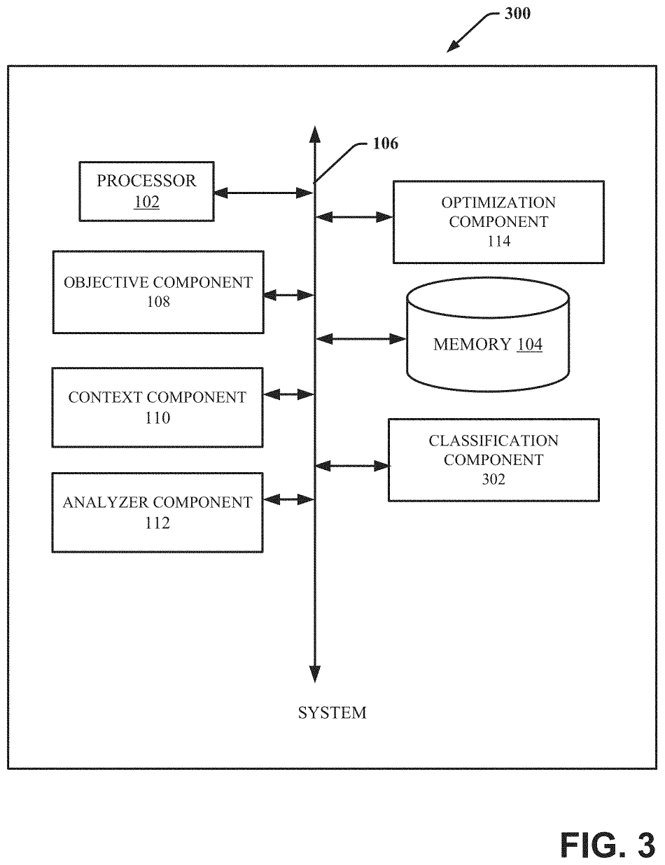

FIG. 3 illustrates a block diagram of yet another example of an optimized transportation selection system in accordance with one or more embodiments described herein. Repetitive description of like elements employed in other embodiments described herein is omitted for sake of brevity.

In certain embodiments, the system 300 includes the classification component 302 that classifies transportation data. In one example, the classification component 302 can classify transportation data based upon the type of transportation. For example, transportation options can be classified in broad categories such as air travel or ground transportation, and ground transportation can be classified in subcategories such as vehicle-based transportation or public transportation. Vehicle-based transportation can be classified into additional subcategories such as cabs, ride-sharing services, private car services and the like. Public transportation can be classified into subcategories such as trains, subways, buses and the like.

In another example, the classification component 302 can classify transportation data based upon attributes such as distance, time, cost and the like. In this example, transportation options can be categorized to match a travel segment in a possible travel itinerary based on or more of such attributes.

In another example, the classification component 302 can classify transportation data based upon qualitative attributes such as reliability, comfort, convenience and the like.

In another example, the classification component 302 can classify transportation data based upon categories of users. For example, the classification component 302 can classify categories of users based on demographic information. In another example, the classification component 302 can classify users employed by a company by seniority or job title or function.

In another example, the classification component 302 can utilize a variety of methods to classify transportation options. For example, the classification component 302 can rely on the source of data when classifying transportation data. Data obtained from a public transportation system such as a train system can be classified in subcategories for public transportation and the train system respectively. In another example, the classification component 302 can utilize third-party classifications such as classifications used by travel booking applications.

In another example, classification of transportation data by the classification component 302 can be modified or supplemented based upon preferences of a user. For example, a user can indicate that airlines associated with the user's frequent flier accounts should be prioritized over other airlines. In this example, the classification component 302 can create an additional classification for airlines associated with the user's frequent flier accounts.

In another example, classifications of transportation data by the classification component 302 associated with business travel of a user can be modified based upon policies of the user's employer. For example, an employer may have a premium seating policy that identifies the premium seating options for each airline that can be used by employees which may be different than the premium seating designations used by the airlines. In another example, classifications of transportation data by the classification component 302 associated with business travel of a user can utilize the classifications of historical travel expenses used by the user's employer.

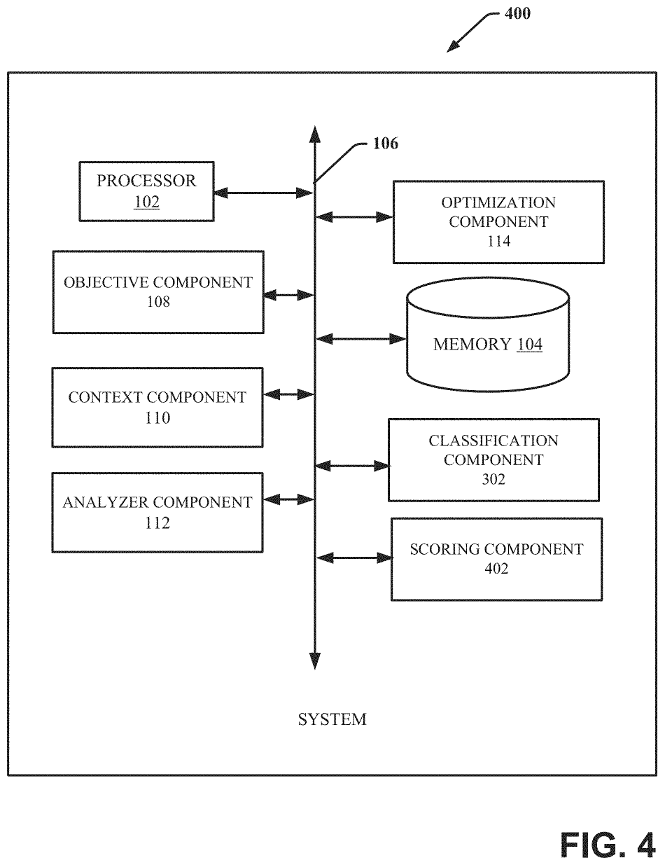

FIG. 4 illustrates a block diagram of yet another example of an optimized transportation selection system in accordance with one or more embodiments described herein. Repetitive description of like elements employed in other embodiments described herein is omitted for sake of brevity. In certain embodiments, the system 400 includes the scoring component 402 that dynamically generates for a user a qualitative score of transportation options from subsets of the transportation data classified by the classification component 302. In one example, the scoring component 402 can generate a qualitative score that includes a combination of scores for quantitative factors such as time and cost and qualitative factors associated with a user's travel preferences and context. For example, the scoring component 402 can utilize a scoring format that generates a numerical score comprising three components: time, cost and qualitative factors. In this example, equal weight can be assigned to each of the three components. Scores for time and cost can be assigned based upon the analysis of transportation data by the analyzer component 112. Scores for qualitative factors can be determined in some cases using a user's direct responses to questions assembled by the objective component 108. Scores for qualitative factors can be inferred in some cases using probabilistic methods based in a user's general travel preferences, trip preferences, travel history, context and the like.

In another example, the scoring component 402 dynamically generates for a user more than one qualitative score of the transportation options from classified subsets of the transportation data. For example, if multiple transportation selections are assigned a score by the scoring component 402 that meet a minimum threshold, then the scoring component 402 can provide to the user each score that meets the minimum threshold. In another example, the scoring component 402 can dynamically generate for a user the components of a score. For example, if the aggregate score generated by the scoring component 402 includes the combination of scores for time, cost and qualitative factors, the scores associated with each of the components can be shared with the user, thus providing the user with additional information that can be used by the user to select among the transportation selections.

In another example, a score generated by the scoring component 402 can be revised by adjusting the weight assigned to the components used by the scoring component 402 to generate the score. For example, a user may want to see what score would be generated by the scoring component 402 if the weight given to the time score is reduced or eliminated. In another example, a user may want to see what score would be generated by the scoring component 402 for a travel segment if more weight is given to the qualitative score for reliability.

In another example, the weight given by the scoring component 402 to components of a score can be modified to conform to the travel policies of a user's employer. For example, travel expense guidelines established by the user's employer may place less emphasis on cost of travel when the user is meeting with key customers. In that case, the scoring component 402 can adjusted to give less weight to the cost score associated with this type of trip.

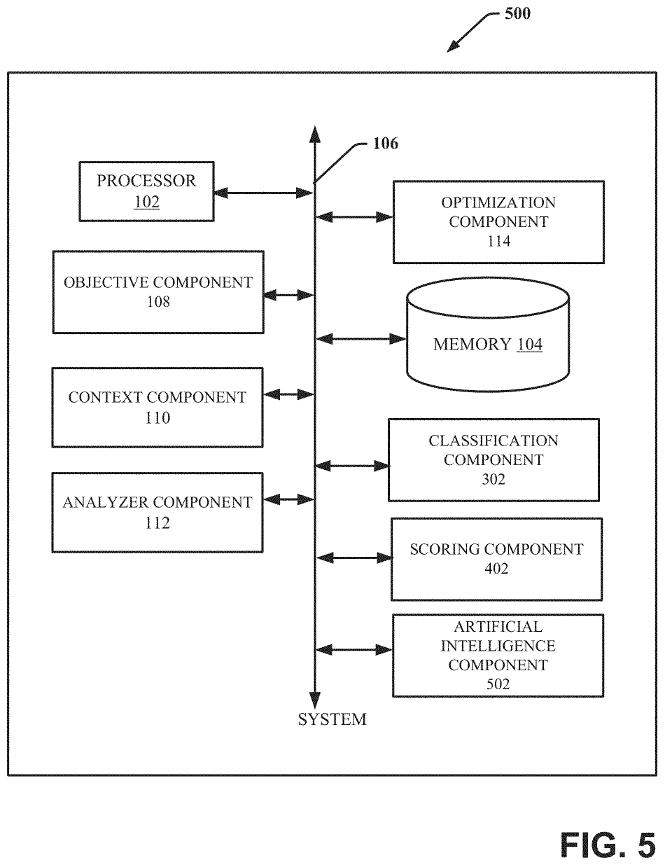

FIG. 5 illustrates a block diagram of yet another example of an optimized transportation selection system in accordance with one or more embodiments described herein. Repetitive description of like elements employed in other embodiments described herein is omitted for sake of brevity. In certain embodiments, the system 500 includes the artificial intelligence component 502 that facilitates the determination of the qualitative score generated by the scoring component 402. For example, the artificial intelligence component 502 can utilize artificial intelligence and machine learning to train one or more aspects of the system 500 to improve the qualitative score generated by the scoring component 402. For example, if a user's behavior over time indicates that the user will only select taking a train as a ground transportation option if a first-class seat is available, then the artificial intelligence component 502 can train the scoring component 402 to adjust the comfort score for the user as it applies to train travel. In addition, the artificial intelligence component 502 can train the objective component 108 to ask additional questions regarding train travel options for the user.

In another example, the artificial intelligence component 502 can analyze crowdsourced data collected from all users of the system 500 in order to detect correlations and trends that can be used to improve one or more aspects of the system 500. For example, the artificial intelligence component 502 may discover that in certain cities, the wait for a vehicle when using a ride sharing application to travel to the airport is often much longer than projected by the analyzer component 112 due to a consistent shortage of available vehicles. In this case, the reliability score assigned to the ride sharing application in the applicable cities can be reduced by the scoring component 402.

In another example, the artificial intelligence component 502 can utilize other data such as publicly available travel statistics in order to improve the system 500. For example, the artificial intelligence component 502 may detect trends or correlations that apply to a subset of users. In one example, the artificial intelligence component 502 may detect that the usage of car rental services is declining for business travelers to Los Angeles and that usage of ride sharing applications by business travelers to Los Angeles is increasing. In this example, the quality scores generated by the scoring component 402 for car rental services and ride sharing applications in Los Angeles can be adjusted to account for this trend.

In this regard, the artificial intelligence component 502 can perform classifications, correlations, inferences and/or expressions associated with principles of artificial intelligence. For instance, the artificial intelligence component 502 can employ an automatic classification system and/or an automatic classification. In one example, the artificial intelligence component 502 can employ a probabilistic and/or statistical-based analysis (e.g., factoring into the analysis utilities and costs) to learn and/or generate inferences. The artificial intelligence component 502 can employ any suitable machine-learning based techniques, statistical-based techniques and/or probabilistic-based techniques. For example, the artificial intelligence component 502 can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, etc. In another aspect, the artificial intelligence component 502 can perform a set of machine learning computations. For example, the artificial intelligence component 502 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

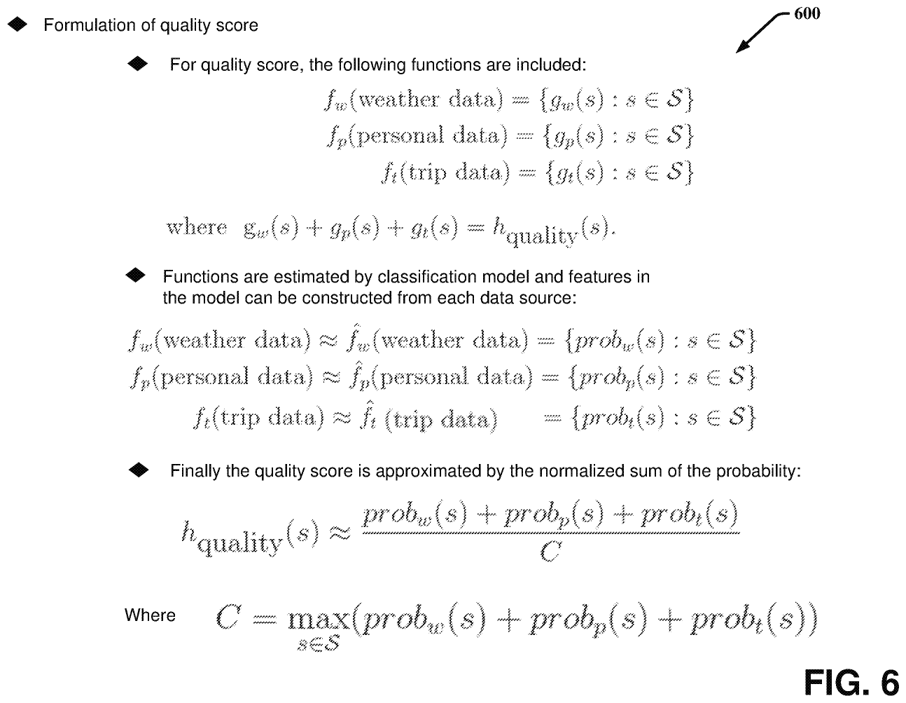

FIG. 6 illustrates an example, non-limiting algorithm 600 to facilitate an optimized transportation selection system in accordance with one or more embodiments described herein. Repetitive description of like elements employed in other embodiments described herein is omitted for sake of brevity. FIG. 6 illustrates an example of a non-limiting algorithm 600 to calculate a quality score generated by the scoring component 402 associated with ground transportation options during a business trip. In this example, a quality score s corresponding to a particular ground transportation option depends on three functions f including weather data w, profile data p and trip data t. Weather data w, profile data p and trip data t each represent data associated with a user's preferences as determined by the objective component 108. Weather data w represents how weather can affect a user's preference associated with ground transportation. Historical weather information coupled with a user's previous ground transportation selections can be used to predict the user's travel preferences in current weather conditions. Profile data p represents how a user's general travel preferences can affect a user's preference associated with ground transportation. Trip data t represents how type of trip can affect a user's preference associated with ground transportation. Functions for weather data w, profile data p and trip data t are estimated by classification model and features in the model for each function can be constructed from data determined by the objective component 108. The quality score s is then approximated by the normalized sum of probability. C represents the maximum score possible for the aggregate probabilities of historical weather, personal profile and trip. Thus, the final quality score s will be normalized to always have score between 0 and 1.

In another example, the quality score s can be combined with quantitative scores such as time and cost scores generated by the scoring component 402 that are also normalized to have a score between 0 and 1 in order to generate an aggregate quality score. In one example, the weighting between the three scores can be equal to generate the aggregate quality score. In another example, the weighting among the three scores can be adjusted in order to adjust the emphasis of the various components in the aggregate quality score.

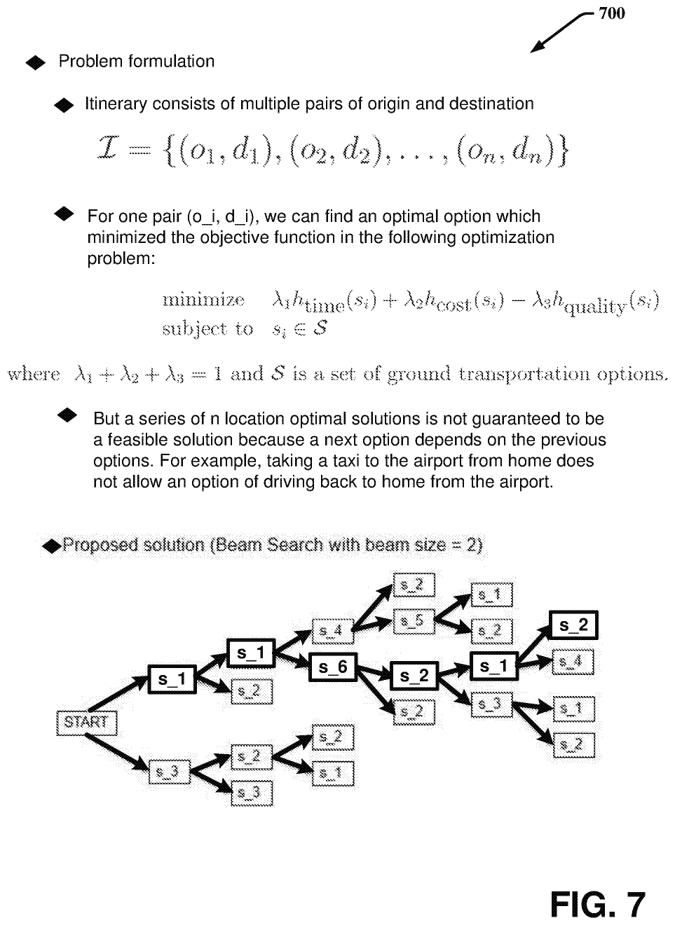

FIG. 7 illustrates an example, non-limiting algorithm 700 to facilitate an optimized transportation selection system in accordance with one or more embodiments described herein. Repetitive description of like elements employed in other embodiments described herein is omitted for sake of brevity. FIG. 7 illustrates an example of a non-limiting algorithm 700 to optimize ground transportation options for a trip itinerary using beam search. In this example, a quality score normalized to have a score between 0 and 1 has been generated as illustrated in FIG. 6 along with quantitative scores for time and cost generated by the scoring component 402 that are also normalized to have a score between 0 and 1. Itinerary I consists of multiple pairs of origin o and destination d. For one pair (o_i, d_i), an optimal option can be determined which minimizes the objective function in the optimization problem on FIG. 7. In this formula, λ equals the number of available ground transportation options. In this formula, λ represents the weight assigned to time, cost and quality. A user can control the weight assigned to each item, but the combination of the three items will always equal 1 (λ1 +λ2+λ3=1). S is a set of ground transportation options. In this problem, a series of n location optimal solutions is not guaranteed to provide a feasible solution because a next option depends on the previous options. For example, taking a cab to an airport from home does not allow an option of driving back to home from the airport. Thus, a dependency table can be created in the context of a beam search in order to select ground transportation options in the itinerary I. Beam search is a heuristic search algorithm that explores a graph by expanding the most promising node in a limited set. Beam search is an optimization of best-first search that increases the speed of search and reduces memory requirements. In this example, a beam search with a beam size of 2 is utilized. Each step represents a set of ground transportation options s_n, with n representing a number corresponding to a feasible ground transportation option. At each step, the next two best transportation options are selected, but only the two best that are feasible given the ground transportation selection made in the previous step.

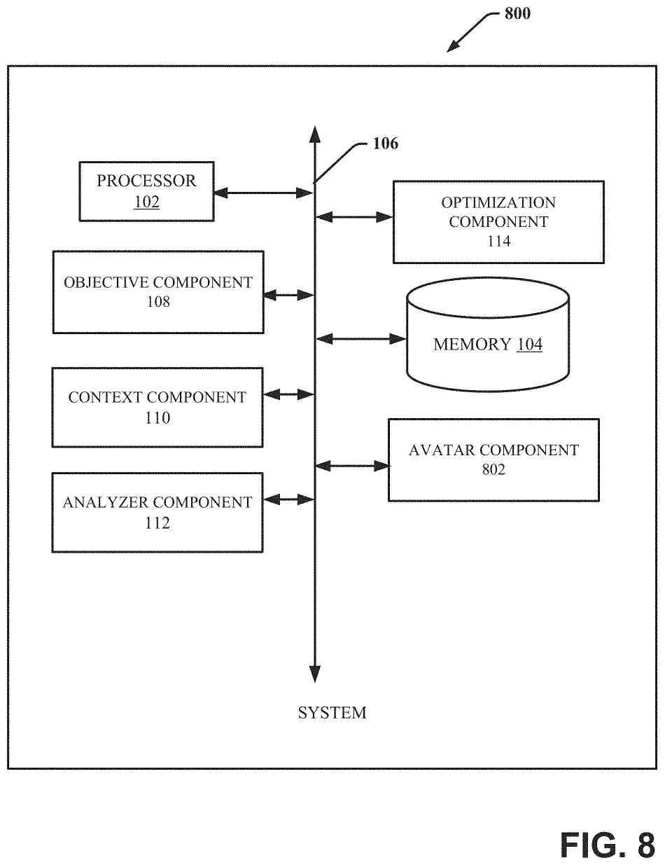

FIG. 8 illustrates a block diagram of yet another example of an optimized transportation selection system in accordance with one or more embodiments described herein. Repetitive description of like elements employed in other embodiments described herein is omitted for sake of brevity. In certain embodiments, the system 800 includes the avatar component 802 that generates an avatar that provides the optimized itinerary generated by the optimization component 114 to a user through a virtual interface. In computing technology, an avatar is a graphical representation of a character or personality provided to convey information to a viewer. An avatar can take a two or three-dimensional human form and be configured to speak and move as would a real person. In this example, some or all of an optimized itinerary generated by the optimization component 114 to a user can be communicated to the user by the avatar component 802 in a conversational format. In another example, the avatar component 802 can enable a user to interact with the virtual avatar with verbal responses or commands. In another example, the avatar component 802 can enable a user to select the form or voice of a virtual avatar from a number of options. In another example, the avatar component 802 can enable a user to customize the form or voice of a virtual avatar.

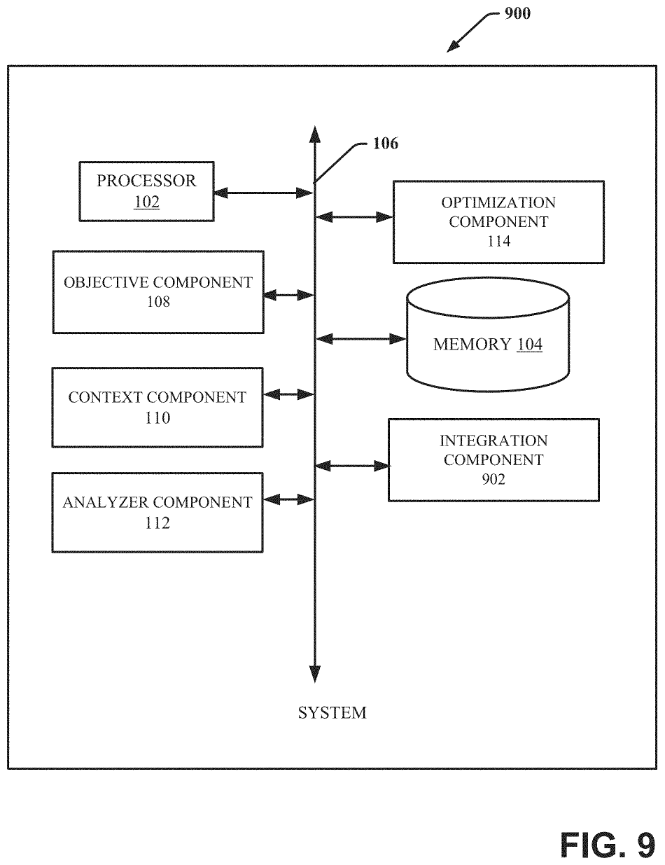

FIG. 9 illustrates a block diagram of yet another example of an optimized transportation selection system in accordance with one or more embodiments described herein. Repetitive description of like elements employed in other embodiments described herein is omitted for sake of brevity. In certain embodiments, the system 900 includes the integration component 902 that integrates the system 900 with other visualization tools. For example, a user can use a calendar application to track personal and business appointments. In this example, the itinerary generated by the optimization component 114 can be dynamically displayed in the user's calendar application. This displayed itinerary can include all travel segments in the itinerary as separate items in the user's calendar application, including ground transportation segments between meetings where the user has not yet selected a transportation option. In this example, the travel segments where the user has not yet selected a transportation option can be color coded or trigger a reminder in order to alert the user that a selection of a transportation option will be required. In another example, travel segments in an itinerary generated by the optimization component 114 for an upcoming trip that require ground transportation can be highlighted in a user's ride sharing application with the destination addresses for each ground transportation segment pre-loaded. In another example, the system 900 can be integrated by the integration component 902 into a wireless mobile device such as a smartphone. For example, the system 900 can enable transportation segments in an itinerary generated by the optimization component 114 to appear as reminders on a user's smartphone in the form of on screen or audio notifications.

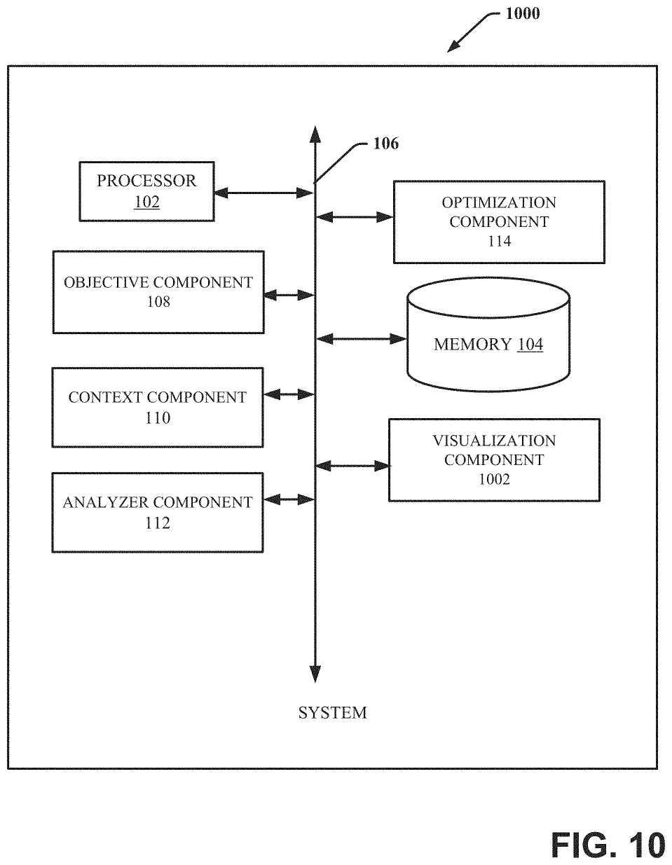

FIG. 10 illustrates a block diagram of yet another example of an optimized transportation selection system in accordance with one or more embodiments described herein. Repetitive description of like elements employed in other embodiments described herein is omitted for sake of brevity. In certain embodiments, the system 1000 includes the visualization component 1002 that facilitates visualizing output from the optimization component 114 in an augmented realty environment. In one example, the visualization component 1002 can display output from the optimization component 114 utilizing an augmented reality component contained in glasses worn by a user in order to overlay text or images onto the user's field of vision. For example, if a user is at a business lunch and has an upcoming meeting across town that requires ground transportation, the visualization component 1002 can display the recommended transportation option from the optimization component 114 overlaid onto the user's field of vision, eliminating the need for the user to check his smartphone or computer to arrangement transportation. In another example, the visualization component 1002 can display directions in the form of arrows overlaid onto the field of vision of a user who is driving or walking. In another example, the visualization component 1002 can highlight a vehicle that the user has ordered using a ride sharing application in the user's field of vision. In another example, the visualization component 1002 can highlight the location of a subway entrance or cab stand. In another example, the visualization component 1002 can translate signs from one language to another and overlay the translated text onto a user's field of vision over the translated sign.

In another embodiment, the visualization component 1002 can be integrated into a multi-modal system that leverages augmented reality, GPS and audio communication to facilitate navigation for a user between or during transportation segments. For example, if a user is traveling in a foreign airport, the multi-model system can provide directions to the user's gate in the form of audio instructions, translations of signs overlaid onto the user's field of vision or navigation instructions overlaid onto the user's field of vision. The multi-model system can also translate spoken words from travel announcements or other individuals and communicate the translated words to the user by audio or by overlaying the translated words in the user's field of vision.

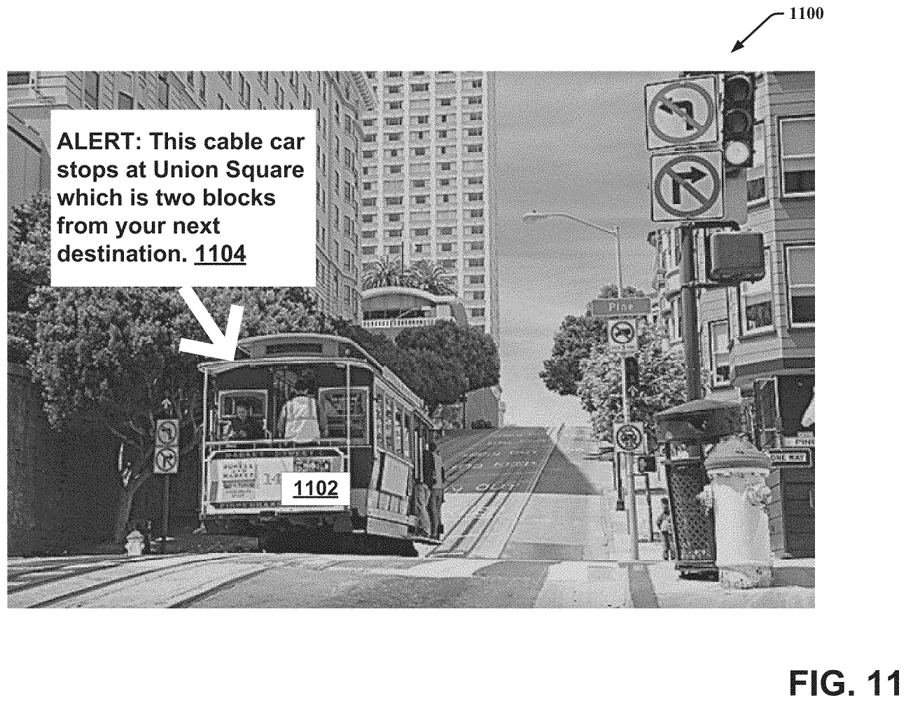

FIG. 11 illustrates yet another example of an optimized transportation selection system in accordance with one or more embodiments described herein. Repetitive description of like elements employed in other embodiments described herein is omitted for sake of brevity. FIG. 11 depicts an example of a field of vision of a user of a street using the visualization component 1002 in an augmented reality environment. In this example, the user can see a cable car which is a public transportation option in San Francisco. The user's next meeting is near Union Square, and the user has not yet selected a ground transportation option because the user has plenty of time to get to the meeting. The user can see the cable car 1102 in the user's field of vision, and the optimization component 114 determines that the cable car 1102 is the best ground transportation option for the user based on the user's location, the cost, the location and destination of the cable car, the time and location of the user's next meeting and the estimated time of arrival of the cable car. This output by the optimization component 114 is communicated to the user by the visualization component 1002 by displaying an alert 1104 overlaid onto the user's field of vision in the augmented reality environment.

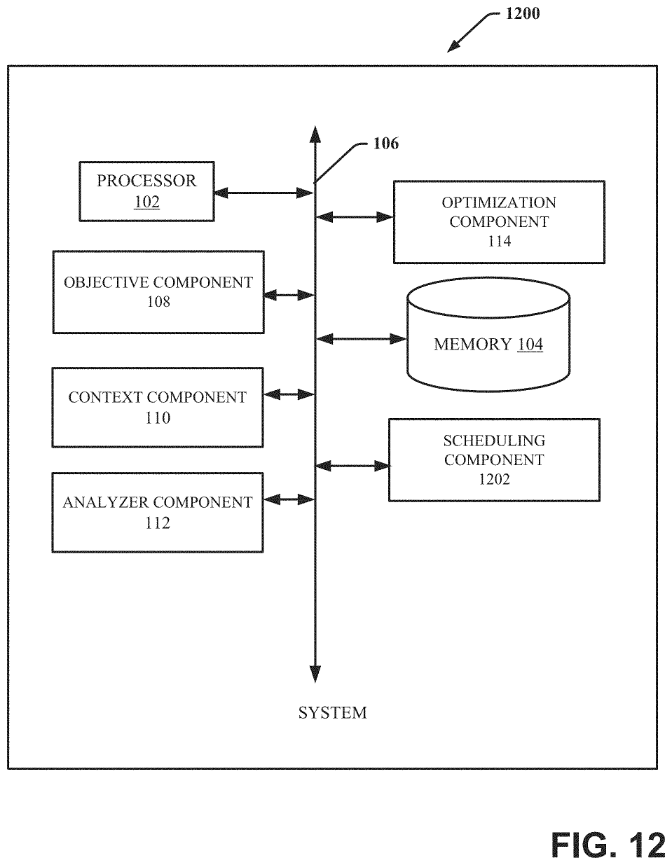

FIG. 12 illustrates a block diagram of yet another example of an optimized transportation selection system in accordance with one or more embodiments described herein. Repetitive description of like elements employed in other embodiments described herein is omitted for sake of brevity. In certain embodiments, the system 1200 includes the scheduling component 1202 that automatically books respective transportation options output by the optimization component 114. In one example, the optimization component 114 can select a ride sharing application for the ground transportation segment of a user's trip and the scheduling component 1202 can order a ride from the ride sharing application. If the ground transportation segment of the user's trip is scheduled immediately following air travel, the scheduling component 1202 can order the ride as the user approaches the ride sharing pickup point in the airport. If the user has checked luggage, the scheduling component 1202 can order the ride only after the user has picked up the user's luggage. If the user is traveling with family members or business associates, the scheduling component 1202 can order an upgrade to a larger vehicle. In another example, the scheduling component 1202 can include settings determined by the objective component 108 associated with the time that the scheduling component 1202 can order different types of transportation options. For example, a user can indicate a preference that any time the optimization component 114 selects a cab as the ground transportation option following a business lunch or dinner out of town, then the scheduling component 1202 can order the cab immediately following the payment of the lunch or dinner bill by the user.

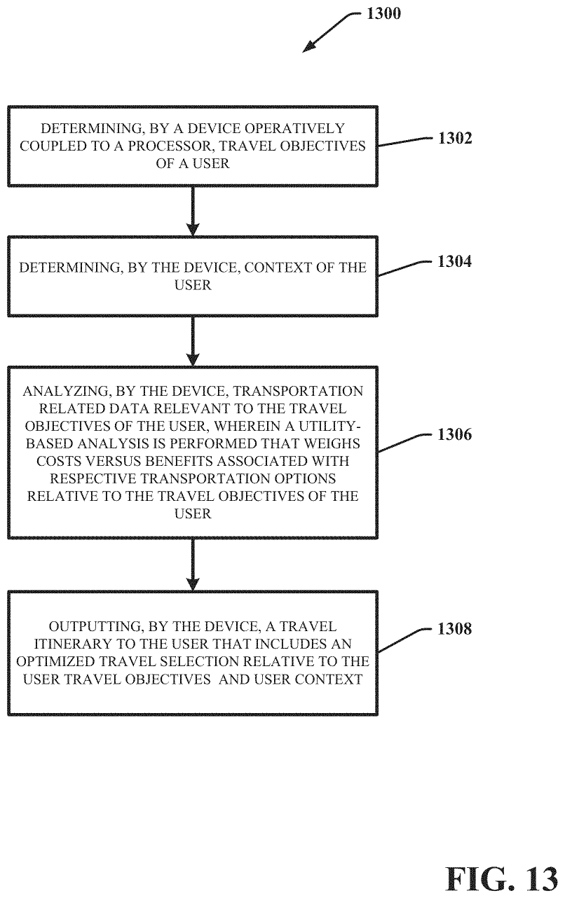

FIG. 13 illustrates a basic method flowchart 1300 of functional acts within various embodiments. Repetitive description of like elements employed in other embodiments described herein is omitted for sake of brevity. 1302 represents a first act that includes determination of travel objectives of a user (e.g., via the objective component 108). At 1304, context of the user is determined (e.g., via the context component 110). At 1306, transportation related data relevant to the travel objectives of the user is analyzed, wherein a utility-based analysis is performed that weighs costs versus benefits associated with respective transportation options relative to the travel objectives of the user (e.g., via the analyzer component 112). At 1308, a travel itinerary is outputted to the user that includes an optimized transportation selection relative to the user travel objectives and user context (e.g., via the assessment component 114).

In certain embodiments, at 1306, the transportation data is classified. In another embodiment, at 1308, a qualitative score of the transportation options is dynamically generated for the user from classified subsets of the transportation data.

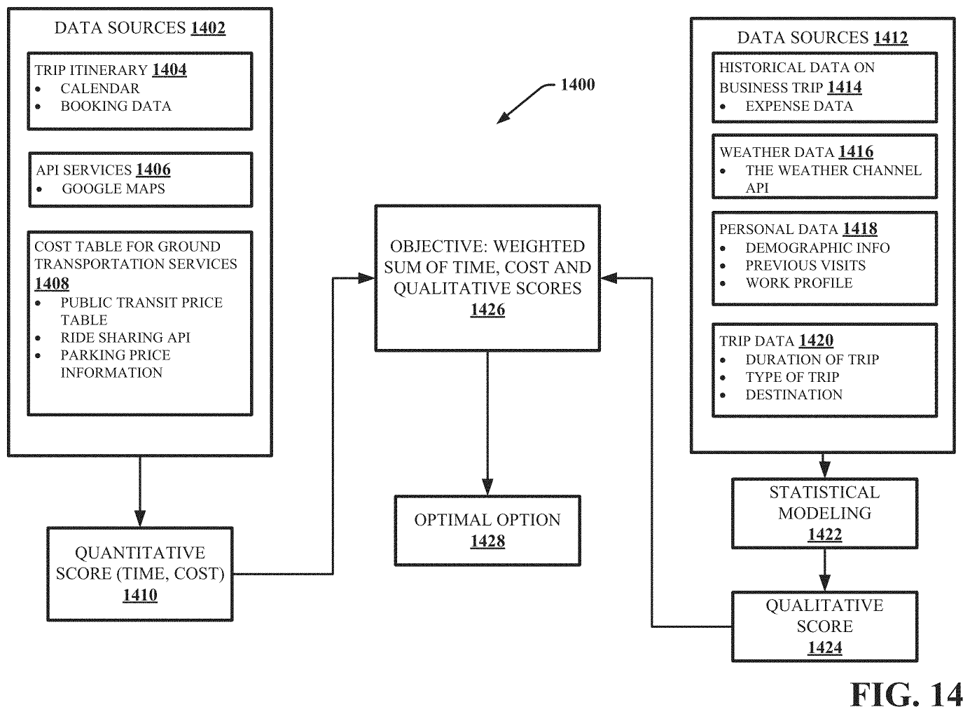

FIG. 14 illustrates another basic method flowchart 1400 of functional acts within various embodiments. Repetitive description of like elements employed in other embodiments described herein is omitted for sake of brevity. The optimized transportation selection method illustrated in FIG. 14 can be implemented in the system 400 of FIG. 4. As such, reference is to be made to the example of FIG. 4 in the following discussion of the example of FIG. 14.

Thus, in the example of FIG. 14, an optimized transportation selection sequence 1400 is outlined. The sequence begins at 1402 where data sources are collected that will enable the calculation of a quantitative score for ground transportation options associated with a trip. At 1404, trip itinerary information is collected from a user's calendar and booking data. At 1406, location data is collected using application programming interface (API) services of an application such as Google Maps. At 1408, a cost table is assembled for ground transportation options using sources such as a public transit price table, ride sharing APIs, parking price information and the like. At 1410, a quantitative score is generated for available transportation options based upon travel time and travel cost. At 1412, data sources are collected that will enable the calculation of a qualitative score for ground transportation options associated with the trip. At 1414, historical data on similar business trips is collected such as expense data. At 1416, weather data is collected using API services from sources such as The Weather Channel. At 1418, personal data of the user is collected such as demographic information, travel insurance, previous visits to the destination of the trip, work profile and the like. At 1420, trip data is collected such as duration of the trip, type of trip and destination. At 1422, statistical modeling is completed in order to classify and assign numerical values to collected data. At 1424, a quantitative score is generated for available transportation options based upon statistical modeling of qualitative data. At 1426, a weighted sum of the quantitative scores for time and cost from 1410 and the qualitative score from 1424 associated with each transportation option is generated. At 1428, an optimal transportation option is generated based upon the highest weighted sum of scores.

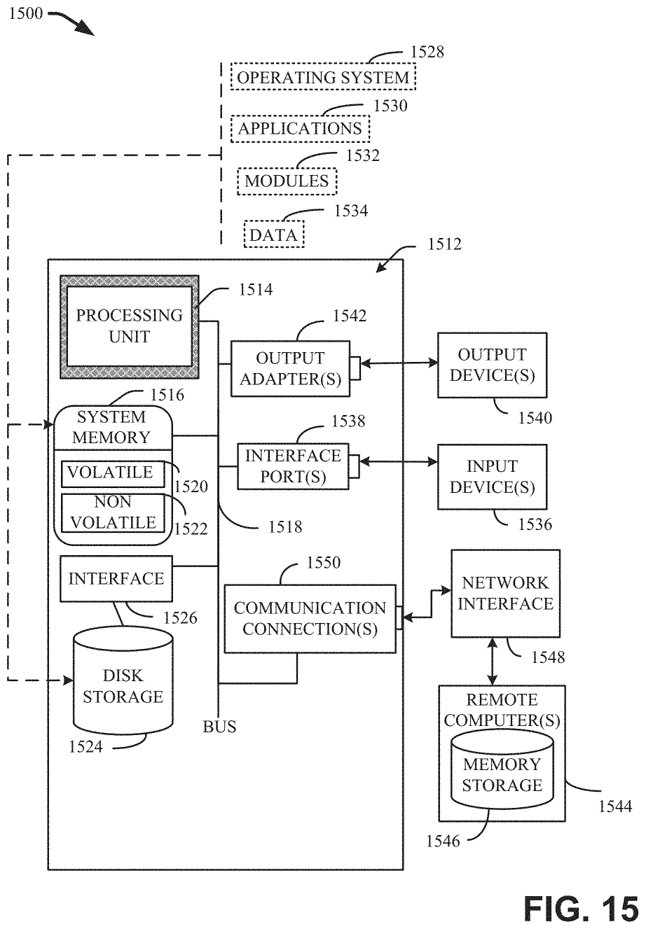

In order to provide a context for the various aspects of the disclosed subject matter, FIG. 15 as well as the following discussion are intended to provide a general description of a suitable environment in which the various aspects of the disclosed subject matter can be implemented. FIG. 15 illustrates a block diagram of an example, non-limiting operating environment in which one or more embodiments described herein can be facilitated. Repetitive description of like elements employed in other embodiments described herein is omitted for sake of brevity.

With reference to FIG. 15, a suitable operating environment 1500 for implementing various aspects of this disclosure can also include a computer 1512. The computer 1512 can also include a processing unit 1514, a system memory 1516, and a system bus 1518. The system bus 1518 couples system components including, but not limited to, the system memory 1516 to the processing unit 1514. The processing unit 1514 can be any of various available processors. Dual microprocessors and other multiprocessor architectures also can be employed as the processing unit 1514. The system bus 1518 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1516 can also include volatile memory 1520 and nonvolatile memory 1522. The basic input/output system (BIOS), containing the basic routines to transfer information between elements within the computer 1512, such as during start-up, is stored in nonvolatile memory 1522. Computer 1512 can also include removable/non-removable, volatile/non-volatile computer storage media. FIG. 15 illustrates, for example, a disk storage 1524. Disk storage 1524 can also include, but is not limited to, devices like a magnetic disk drive, floppy disk drive, tape drive, Jaz drive, Zip drive, LS-100 drive, flash memory card, or memory stick. The disk storage 1524 also can include storage media separately or in combination with other storage media. To facilitate connection of the disk storage 1524 to the system bus 1518, a removable or non-removable interface is typically used, such as interface 1526. FIG. 15 also depicts software that acts as an intermediary between users and the basic computer resources described in the suitable operating environment 1500. Such software can also include, for example, an operating system 1528. Operating system 1528, which can be stored on disk storage 1524, acts to control and allocate resources of the computer 1512.

System applications 1530 take advantage of the management of resources by operating system 1528 through program modules 1532 and program data 1534, e.g., stored either in system memory 1516 or on disk storage 1524. It is to be appreciated that this disclosure can be implemented with various operating systems or combinations of operating systems. A user enters commands or information into the computer 1512 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port can be used to provide input to computer 1512, and to output information from computer 1512 to an output device 1540. Output adapter 1542 is provided to illustrate that there are some output devices 1540 like monitors, speakers, and printers, among other output devices 1540, which require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a computer, a server, a router, a network PC, a workstation, a microprocessor-based appliance, a peer device or other common network node and the like, and typically can also include many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1550 refers to the hardware/software employed to connect the network interface 1548 to the system bus 1518. While communication connection 1550 is shown for illustrative clarity inside computer 1512, it can also be external to computer 1512. The hardware/software for connection to the network interface 1548 can also include, for exemplary purposes only, internal and external technologies such as, modems including regular telephone grade modems, cable modems and DSL modems, ISDN adapters, and Ethernet cards.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes computer executable components stored in the memory;
an objective component that determines travel objectives of a user;
a context component that determines context of the user;
an analyzer component that analyzes transportation related data relevant to the travel objectives of the user, wherein the analyzer component performs a utility-based analysis that weighs costs versus benefits associated with respective transportation options relative to the travel objectives of the user; and
an optimization component that outputs a travel itinerary to the user that includes an optimized transportation selection relative to the user travel objectives and user context.

2. The system of claim 1, further comprising a classification component that classifies the transportation data.

3. The system of claim 2, further comprising a scoring component that dynamically generates for the user a qualitative score of the transportation options from classified subsets of the transportation data.

4. The system of claim 1, wherein the optimization component factors financial costs associated with respective transportation options and cost associated with the user being late to a destination.

5. The system of claim 1, further comprising an avatar component that generates an avatar that provides the optimized itinerary to the user through a virtual interface.

6. The system of claim 1, further comprising an integration component that integrates the system with other visualization tools.

7. The system of claim 1, wherein the analyzer component employs crowdsourced data to facilitate analysis of the transportation options.

8. The system of claim 3, further comprising an artificial intelligence component that facilitates the determination of the qualitative score.

9. The system of claim 1, further comprising a visualization component that facilitates visualizing output from the optimization component in an augmented realty environment.

10. The system of claim 6, wherein the integration component dynamically transitions and executes the system on a wireless mobile device.

11. The system of claim 1, wherein the optimization component dynamically revises the itinerary based on an event.

12. The system of claim 1, further comprising a scheduling component that automatically books respective transportation options output by the optimization component.

13. A computer-implemented method comprising:
determining, by a device operatively coupled to a processor, travel objectives of a user;
determining, by the device, context of the user;
analyzing, by the device, transportation related data relevant to the travel objectives of the user, wherein a utility-based analysis is performed that weighs costs versus benefits associated with respective transportation options relative to the travel objectives of the user; and
outputting, by the device, a travel itinerary to the user that includes an optimized transportation selection relative to the user travel objectives and user context.

14. The method of claim 13, further comprising classifying the transportation data.

15. The method of claim 14, further comprising dynamically generating for the user a qualitative score of the transportation options from classified subsets of the transportation data.

16. The method of claim 13, further comprising factoring financial costs associated with respective transportation options and cost associated with the user being late to a destination.

17. The method of claim 13, further comprising employing crowdsourced data to facilitate analysis of the transportation options.

18. The method of claim 15, further comprising using artificial intelligence to facilitate the determination of the qualitative score.

19. A computer program product comprising a computer readable storage medium having program instructions embodied therewith, the program instructions are executable by a processor to cause the processor to:
determine, by the processor, travel objectives of a user;
determine, by the processor, context of the user;
analyze, by the processor, transportation related data relevant to the travel objectives of the user, wherein a utility-based analysis is performed that weighs costs versus benefits associated with respective transportation options relative to the travel objectives of the user; and
output, by the processor, a travel itinerary to the user that includes an optimized transportation selection relative to the user travel objectives and user context.

20. The computer program product of claim 19, further comprising:
classifying, by the processor, the transportation data; and
dynamically generating, by the processor, a qualitative score for the user of the transportation options from classified subsets of the transportation data.
